(19) United States
(12) Patent Application Publication
(10) Pub. No.: US 2017/0266475 A1
(43) Pub. Date: Sep. 21, 2017

(54) COMPRESSED AIR FOAM SYSTEM WITH IN-TANK MANIFOLD

(71) Applicant: David G. Mahrt, Redding, CA (US)

(72) Inventor: David G. Mahrt, Redding, CA (US)

(21) Appl. No.: 15/464,124

(22) Filed: Mar. 20, 2017

Related U.S. Application Data
(60) Provisional application No. 62/311,166, filed on Mar. 21, 2016.

(51) Int. Cl. A62C 5/02

(52) U.S. Cl. CPC A62C 5/022

(57) ABSTRACT

A fire suppression system may include a tank and a manifold in the tank. The tank, when charged, holds a liquid pressurized with a gas. The manifold has an inlet coupled to receive a liquid flow from a lower portion of the tank and an inlet configured to receive a gas flow from a upper portion of the tank. An expansion chamber in the manifold receives the liquid flow and the gas flow and is shaped to mix the liquid and gas flows and thereby produce foam.

### CROSS-REFERENCE TO RELATED APPLICATIONS

This patent document is claims benefit of the earlier filing date of U.S. provisional Pat. App. No. 62/311,166, filed Mar. 21 2016, which is hereby incorporated by reference in its entirety.

### BACKGROUND

Conventional CAFSs (Compressed Air Foam Systems) for fire suppression generally create foam by mixing a liquid solution containing water and foam concentrate from an extinguisher tank with an air flow from either an air compressor or a high-pressure air cylinder, e.g., a flow from a cylinder pressurized to about 3200 psi to 6000 psi regulated down to a safe working pressure. The compressor or high-pressure air cylinder can be cumbersome, difficult to maintain, and adds to the cost of the fire suppression system.

### BRIEF DESCRIPTION OF THE DRAWINGS

FIG. 1 shows an implementation of a two-piece manifold including an expansion chamber for generating fire suppressing foam.

FIG. 2 shows an implementation of a fire suppression system having a manifold including an expansion chamber installed within a pressurized tank.

FIG. 3 shows a manifold in accordance with an implementation using air inlets of different sizes.

FIG. 4 shows a manifold in accordance with an implementation using inlets with replaceable jets.

FIGS. 5A and 5B show perspective views of a manifold in accordance with an implementation having removable jets and storage pockets for the jets.

The drawings illustrate examples for the purpose of explanation and are not of the invention itself. Use of the same reference symbols in different figures indicates similar or identical items.

### DETAILED DESCRIPTION

A CAFS (Compressed Air Foam System) with an in-tank manifold including an expansion chamber may eliminate the need for a high-pressure air cylinder or other gas supply separate from a tank containing a foam solution. A CAFS fire extinguisher may thus avoid drawbacks of high-pressure cylinders, which add to the system costs and can be cumbersome and difficult to refill. Accordingly, a CAFS System with an in-tank manifold may be smaller, lighter, less expensive, and easier to use and maintain than a conventional CAFS System.

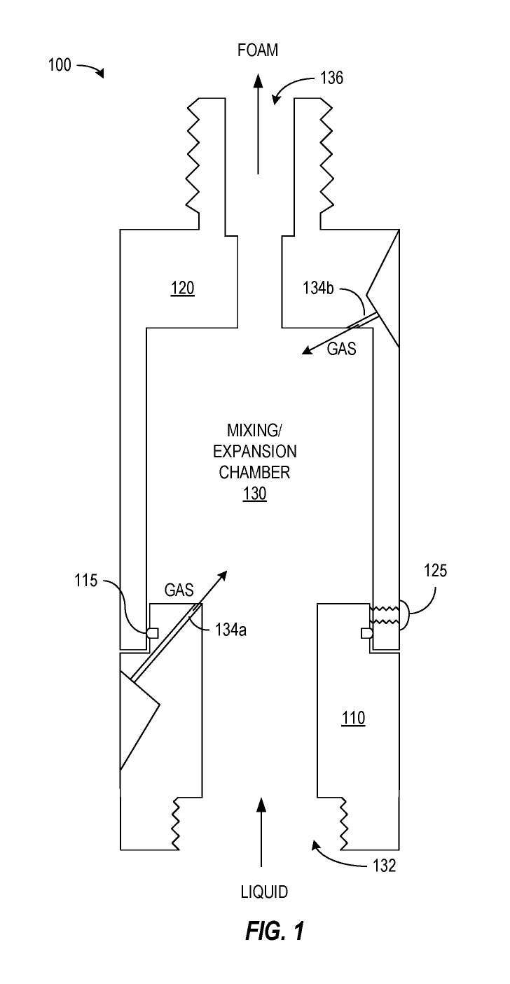

FIG. 1 shows an in-tank manifold 100 for a CAFS system in accordance with one implementation of the invention. Manifold 100 may be sized to fit inside the tank of a conventional fire extinguisher, and in one specific implementation may be about 4 to 5 inches long and about 1 to 1.25 inches in diameter, which allows insertion or removal of manifold 100 through the top opening in many conventional fire extinguisher tanks. In the illustrated configuration of FIG. 1, manifold 100 includes two major pieces 110 and 120, which may be made from any material of suitable strength and temperature tolerance. For example, manifold pieces 110 and 120 may be machined or otherwise made from a metal such as aluminum or stainless steel or from a high-strength plastic. Pieces 110 and 120 are shaped to fit together to create or define an expansion chamber 130 for mixing of gas and solution to produce foam. FIG. 1 shows an implementation in which pieces 110 and 120 have mating portions that slip together, and one or more set screws 125 holds pieces 110 and 120 in place. An o-ring seal 115 between pieces 110 and 120 may prevent unwanted fluid flow into or leakage between manifold pieces 110 and 120. Alternatively, pieces 110 and 120 may be screwed together by threads or close fit and pressed together as described below, which may also prevent unwanted flow or leakage between manifold pieces 110 and 120 without need of an o-ring. The two-piece construction of manifold 100 has the advantage of permitting machining of manifold pieces 110 and 120 to provide expansion chamber 130 with a diameter larger than the diameters of the inlets and outlets of expansion chamber 130. Alternatively, casting or molding may be able to produce a one-piece construction for a manifold including an expansion chamber.

Expansion chamber 130 is created when manifold piece 120 threads, slips, or is pressed onto manifold piece 110. Expansion chamber 130 may be cylindrical. Expansion chamber 130 as shown in FIG. 1 has one or more inlets 132 for liquid, one or more inlets 134a and 134b for gas, and one or more outlets 136 for foam. Liquid inlet 132 of manifold 100 is shaped to engage a dip tube, which may provide a feed of a water/concentrated foam mix. In the illustrated configuration, liquid inlet 132 is in bottom piece 110 of the manifold 100 and has threads, e.g., standard ½″ pipe thread, into which a dip tube may be threaded. Expansion chamber 130 may have an interior diameter larger than an interior diameter of inlet 132, so that expansion or turbulence occurs when foam concentrate enters expansion chamber 130 through inlet 132. More particularly, expansion chamber 130 and inlet 132 may be sized to provide an interior pressure in expansion chamber 130 that is suitably less than the pressure of the solution entering through inlet 132. For example, expansion chamber 130 may have an interior diameter of about 1 inch when inlet 132 has an interior diameter restricted to about ½ inch.

A bottom gas inlet 134a into expansion chamber 130 may be offset and/or at an angle, e.g., at 30°, with the fluid flow into expansion chamber 130, and a top gas inlet 134b may similarly be offset and/or at an angle, e.g., at 30°. The offsets or angles of inlets 134a and 134b relative to liquid inlet 132 may vary but may assist in creating a liquid-gas vortex in expansion chamber 130, which may help mix liquid from inlet 132 and gas from inlets 134a and 134b to create foam. In the implementation of FIG. 1, bottom air inlet 134a is in manifold piece 110 and top air inlet 134b is in manifold piece 120, but other configurations are possible. With the configuration of gas inlets 134a and 134b shown in FIG. 1, top inlet 134b may shoot a stream of air down into expansion chamber 130 and bottom inlet 134a may shoot a stream of air up into expansion chamber 130, which may create a vortex that helps expand the foam chemical and water solution entering through liquid inlet 132 in manifold piece 110.

Foam created in expansion chamber 130 flows out of foam outlet 136, which in the illustrated configuration is formed in manifold piece 120. A restriction or reduced diameter hole may be provided in outlet 136 to enhance a pressure differential between outlet 136 and expansion chamber 130, which may also increase or improve turbulence, expansion, or mixing in chamber 130. For example, a restriction in outlet 136 may be about ⅜ inches in diameter when expansion chamber 130 is about 1 inch in diameter. Foam outlet 136 may thread into a release valve of a fire suppression system, e.g., into a standard squeeze handle of the 2½ gallon stainless steel water fire extinguisher. The release valve may be opened to start liquid and gas flow into expansion chamber 130 and to release the foam from expansion chamber 130.

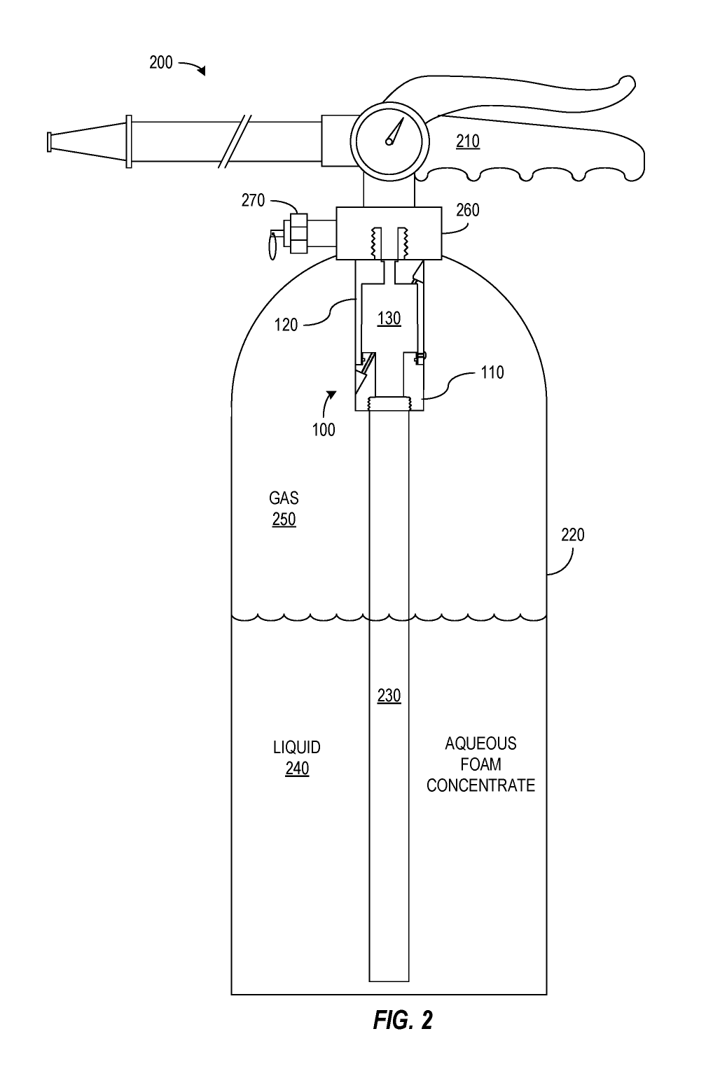

FIG. 2 illustrates a fire suppression system 200 in accordance with an implementation using in-tank manifold 100 of FIG. 1. In system 200, manifold 100 attaches to a squeeze handle 210. FIG. 2 shows a specific implementation in which manifold 100 is threaded into a fitting 260 for a pressure relief valve, and fitting 260 attaches squeeze handle 210 to a tank 220. Alternatively, the foam outlet of manifold 100 may directly thread into squeeze handle 210. In either case, squeeze handle 210 with or without fitting 260 attaches to and seals tank 220 in a conventional manner for fire extinguishers so that tank 220 may be pressurized to a desired working pressure while manifold 100 is within tank 220. As shown in FIG. 2, tank 220 includes a single compartment that is partially filled with an aqueous foam concentrate 240, e.g., Class A foam concentrate, aqueous film forming foam (AFFF) concentrate, or polar solvent foam concentrate mixed with water, and is pressurized with a gas 250, e.g., air at about 100 to 300 psi or more. Tank 220 may, for example, be a 2½ gallon stainless steel tank such as commonly employed for some fire extinguishers, but tank 220 may alternatively be of any size and construction capable hold liquid and gas under suitable pressure.

Manifold 100 in the illustrated embodiment is near the top of tank 220 and in the gas filled portion of tank 220, and a dip tube 230 threads into the liquid inlet of manifold 100 and extends into a liquid filled portion of tank 220 and particularly down to near the bottom of a tank 220. In operation, a user depresses a portion of squeeze handle 210 opening a valve so that the higher pressure in tank 220 forces liquid 240 and gas 250 toward the lower pressure outside tank 220. Liquid 240 particularly flows up dip tube 230 and into expansion chamber 130. Since manifold 100 and its gas inlets are above the level of liquid 240, gas 250 flows through the gas inlets of manifold 100 into mixing/expansion chamber 130. The mixing of liquid 240 and gas 250 in chamber 130 forms fire suppressant foam that exits through squeeze handle 210 and a nozzle that can direct the foam for fire suppression.

Tanks used in current pressurized fire extinguishers are commonly hydro-tested up to 300 psi and are rated for working pressures of about 100 psi to 160 psi. Operating system 200 at a higher pressure up to 200 or 300 psi or more allows system 200 to be filled with a greater volume of liquid 240, while pressure of gas 250 maintains a strong stream of foam from system 200. System 200 may thus be able to provide more suppressant foam than do conventional CAFS extinguishers.

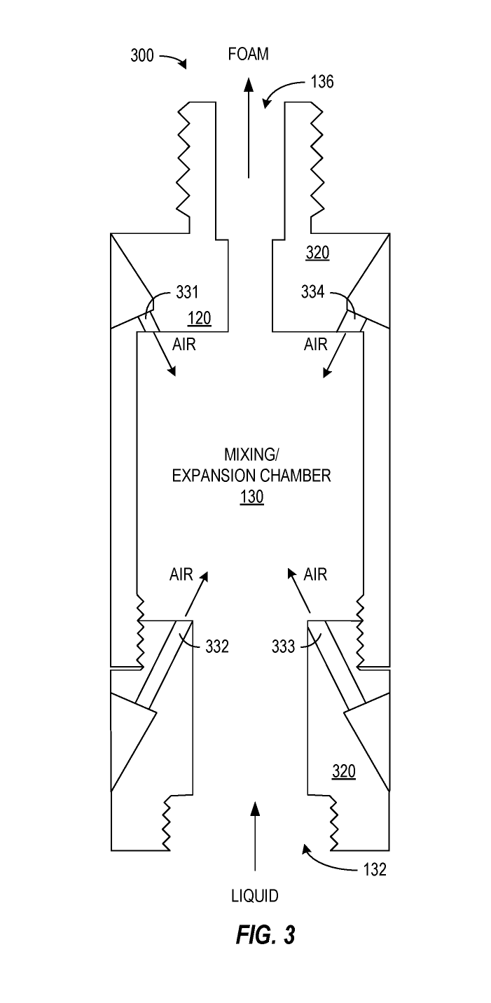

FIG. 3 shows an in-tank manifold 300 including a bottom piece 310 and a top piece 320 in accordance with another implementation. Manifold 300 may include many of the same features as described above for manifold 100. In particular, pieces 310 and 320 connect together to form an expansion chamber 130 having an liquid inlet 132 and a foam outlet 136, which may have the characteristics described above. FIG. 3 further illustrates how manifold 300 may include multiple gas inlets 331, 332, 333, and 334 having fixed or drilled sizes, which may be different. For example, one inlet 331 may provide the smallest diameter or area gas inlet to expansion chamber 130, inlet 332 may be larger than inlet 331, inlet 333 may be larger than inlet 332, and inlet 334 may provide the largest diameter or area gas inlet to chamber 130. The increasing size may be in an order that directs a mixing circulation of liquid and gas in chamber 130.

FIG. 3 also illustrates how manifold pieces 310 and 320 may be threaded together to create a chamber 130 that is larger than its inlets and outlets.

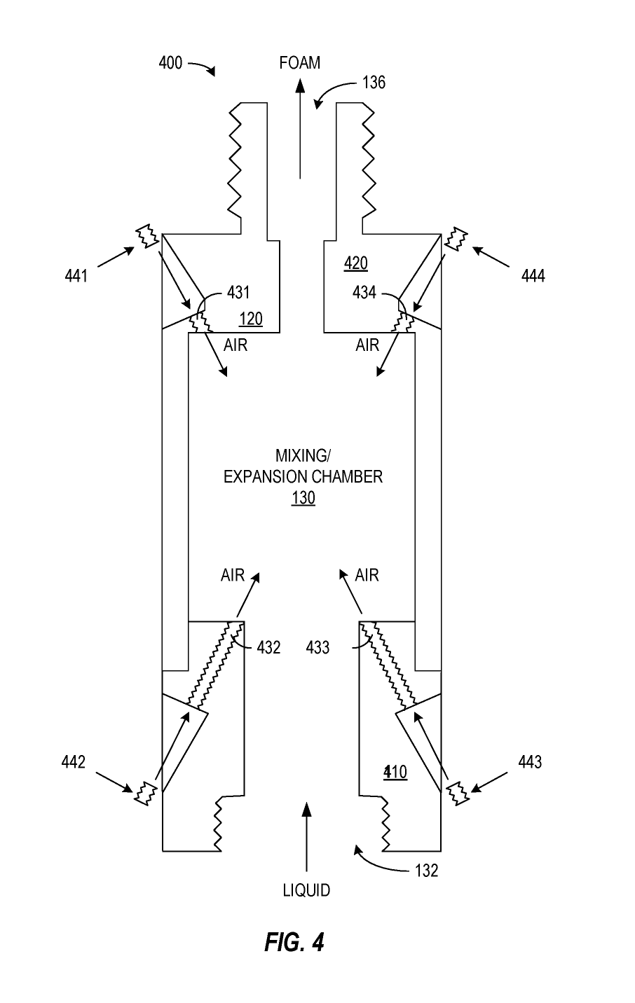

FIG. 4 shows an in-tank manifold 400 that may include many of the same features as described above for manifold 100 or 300. In particular, pieces 410 and 420 of manifold 400 connect together to form an expansion chamber 130 having an liquid inlet 132 and a foam outlet 136, which may have the characteristics described above. Manifold 400 also includes a series of threaded gas inlets 431, 432, 433, and 434 in manifold pieces 410 and 420 and sized for installation of replaceable jets 441, 442, 443, and 444. For example, an Allen wrench can be used to install jets 441 to 444 in respective gas inlets 431 to 434 or remove the jets from the gas inlets. Each installed jet 441, 442, 443, and 444 has an orifice that limits the gas or air flow through the corresponding inlet 431, 432, 433, and 434. The orifices in jets 441, 442, 443, and 444 may all be the same size, or one or more of jets 441, 442, 443, and 444 may have different sizes. In some configurations, one or more of jets 441, 442, 443, and 444 may be omitted, and the diameters of inlets 431, 432, 433, and 444 without a jet defines a maximum orifice size. In one configuration, the orifices may be about 1/16 inch in diameter or smaller and inlets 431 to 424 may be about ¼ inch in diameter. Depending on the orifice size or sizes in the installed jets 441, 442, 443, and 444, manifold 400 may produce a drier or wetter foam. In particular, jets with a smaller orifices may be employed when a wetter foam is desired, or jets with larger orifices may be employed when a drier foam is desired.

Jets 441, 442, 443, and 444 installed in inlets 431, 432, 433, and 434 may be chosen to achieve the same effects as described above for manifold 300 of FIG. 3. For example, in the direction of circulation in chamber 130, jet 441 may have the smallest diameter or area orifice, jet 442 may have a larger orifice than does jet 441, jet 443 may have a larger orifice than does jet 442, and jet 444 may have the largest diameter or area orifice. The increasing size of the orifices and increasing air flows that result may be in an order that directs a mixing circulation of liquid and gas in chamber 130.

FIG. 4 also illustrates how manifold pieces 410 and 420 may be tight fit and pressed together to create an expansion chamber 130 that is larger than inlets and outlets of expansion chamber 130. In particular, one manifold piece 410 or 420 may have a male mating portion with an outside diameter that is the same as or slightly larger than an inside diameter of a female mating portion of the other manifold piece 420 or 410. During manufacture of manifold 400, mating portions of manifold pieces 410 and 420 may be aligned, and a vise or press may apply pressure to force one mating portion into the other. If desired manifold 410 or 420 with the female mating portion may be heated. In any case, the tight fit may hold manifold pieces together without need of threads or a set screw.

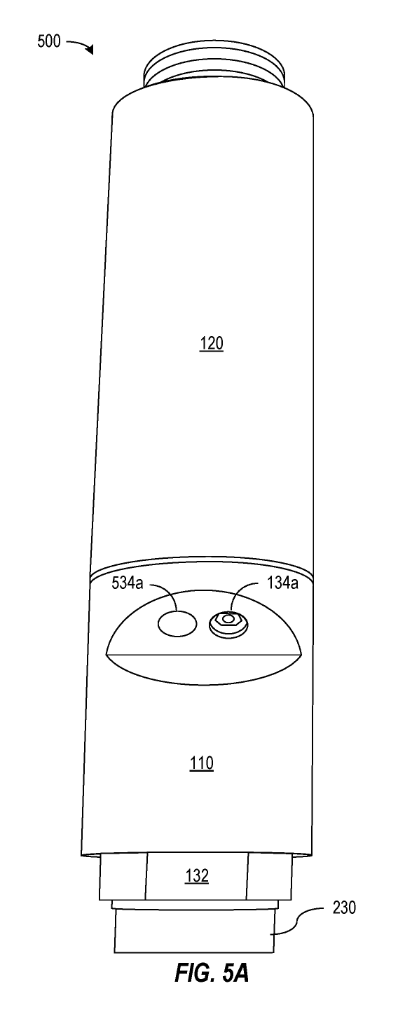

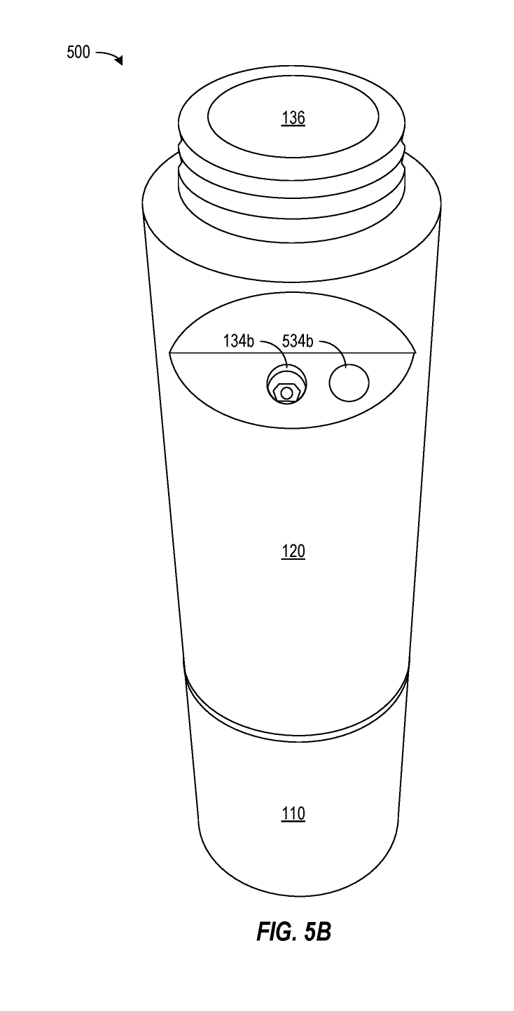

FIGS. 5A and 5B show exterior views of a manifold 500 that may have the same features as the manifolds described above. In particular, manifold 500 includes two pieces 110 and 120 that engage each other to create a mixing or expansion chamber having one or more liquid inlet 132, one or more gas inlet 134a and 134b, and one or more foam outlet 136. Gas inlets 134a and 134b in manifold 500 extend through piece 110 or 120 to the expansion chamber and are threaded. Accordingly, jets may be screwed into either gas inlets 134a and 134b to control the size of the orifices through which gas flows into the expansion chamber. Manifold 500 further includes pockets 534a and 534b that may have the same threading as gas inlets 134a and 134b but do not extend through piece 110 or 120 to the expansion chamber. Accordingly, no gas flows through pocket 534a or 534b, but a jet may be screwed into either pocket 534a or 534b for storage when not in use. For example, manifold 500 may come with multiple jets with different size orifices for use in inlets 134a and 134b, and a user may select jets according to whether a drier or a wetter foam is desired. The user can then screw selected jets into gas inlets 134a and 134b and screw the spare jets into pockets 534a and 534b. Alternatively, manifold 500 may have a single jet for each gas inlet 134a or 134b and may give a user the option to use the jets in gas inlet 134a and 134b to restrict air flow into the mixing or expansion chamber or screw the unused jets into pocket 534a or 534b for unrestricted flow through gas inlets 134a or 134b.

Although particular implementations have been disclosed, these implementations are only examples and should not be taken as limitations. Various adaptations and combinations of features of the implementations disclosed are within the scope of the following claims.

What is claimed is:

1. A fire suppression system comprising:
a tank holding a liquid pressurized with a gas; and
a manifold disposed in the tank and including a first inlet coupled to receive a liquid flow from a first portion of the tank, a second inlet configured to receive a gas flow from a second portion of the tank, and an expansion chamber coupled to receive the liquid flow and the gas flow and shaped to mix the liquid and gas flows and thereby produce foam.

2. The system of claim 1, further comprising a valve coupled to control a flow of the foam from the manifold.

3. The system of claim 1, wherein the manifold comprises:
a first manifold piece; and
a second manifold piece that attaches to first manifold piece, so that a cavity between the first and the second manifold piece forms the expansion chamber.

4. The system of claim 3, wherein:
the first inlet and the second inlet extend through the first manifold to the expansion chamber; and
the second manifold piece comprises a third inlet configured to receive a gas flow from the second portion of the tank.

5. The system of claim 4, wherein the second manifold piece further comprises an outlet configured to direct a foam flow out of the expansion chamber.

6. The system of claim 3, wherein the first manifold piece attaches to the second manifold piece using structure selected from a group consisting of:
complementary threading that attaches the second manifold piece to the first manifold piece;
mating portions of the first and second manifold pieces that are pressed together; and
a set screw that holds mating portions of the first and second manifold together.

7. The system of claim 1, wherein the second inlet is one of a plurality of gas inlets in the manifold and directing gas flows into the expansion chamber.

8. The system of claim 7, wherein the gas inlets increase in size in a direction of circulation in the expansion chamber.

9. The system of claim 1, wherein the liquid comprises a water/concentrated foam mix.

10. The system of claim 1, wherein the gas comprises air.

11. The system of claim 1, wherein the first inlet restricts the liquid flow so that expansion occurs where the liquid flow enters the expansion chamber.

12. The system of claim 1, wherein the gas flow through the second inlet and the liquid flow through the first inlet are at a non-zero angle.

13. The system of claim 1, wherein the angle between the gas flow and the liquid flow contributes to creation of a vortex flow in the expansion chamber.

14. The system of claim 1, wherein the second inlet contains a removable jet having an orifice that limits the gas flow through the second inlet.

15. The system of claim 14, wherein the manifold further comprises a pocket sized to hold the removable jet when the removable jet is removed from the second inlet.

16. A system comprising:
a first manifold piece;
a second manifold piece that attaches to the first manifold piece to enclose a chamber;
a liquid inlet into the chamber;
a foam outlet from the chamber; and
first and second gas inlets configured to conduct gas flows from an exterior of the first and second manifold pieces into the chamber where the gas flows mix with liquid to create foam.

17. The system of claim 16, wherein:
the first gas inlet extends through the first manifold piece to the chamber; and
the second gas inlet extends through the second manifold piece to the chamber.

18. The system of claim 16, wherein the first manifold piece and the second manifold piece have complementary threading that attaches the second manifold piece to the first manifold piece.
